(19) United States
(12) Patent Application Publication
(10) Pub. No.: US 2016/0017984 A1
(43) Pub. Date: Jan. 21, 2016

(54) SHIFTER FOR MANUAL TRANSMISSION

(71) Applicant: Steve Puffpaff, Stevensville, MD (US)

(72) Inventor: Steve Puffpaff, Stevensville, MD (US)

(21) Appl. No.: 14/618,584

(22) Filed: Feb. 10, 2015

Related U.S. Application Data
(60) Provisional application No. 62/026,543, filed on Jul. 18, 2014.
(60) Provisional application No. 62/030,177, filed on Jul. 29, 2014.

(51) Int. Cl. F16H 59/02; F16H 59/04

(52) U.S. Cl. CPC F16H 59/0208; F16H 59/04

(57) ABSTRACT

A system and method for improving manual transmission shifters by improving accuracy and precision without introducing undesirable vibration. The system and method of this invention addresses shifting difficulty while limiting vibration, especially in performance automobiles, by providing multiple connection points between the transmission and shifter. The claimed invention is particularly desirable in its ability to optimize semi-remote shifters where many previous attempts have not been able to adequately remedy this problem.

### CROSS REFERENCE TO RELATED APPLICATIONS

This application is the provisional application of a utility patent application filed within 12 months and claiming priority under 35 U.S.C. §119(e).

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### INCORPORATION BY REFERENCE OF ELECTRONIC MEDIA

Not Applicable

### STATEMENT REGARDING PRIOR DISCLOSURES

Not Applicable

### BACKGROUND OF THE INVENTION

1. Field of the Invention

A system and method are described for providing improved shifters for manual transmissions, especially for semi-remote transmissions. This invention relates to engine transmissions for vehicles generally, and especially for high performance automobile manual transmissions and similar transmissions. The system and method employ a novel design of multiple connections between the shifter and transmission, described in the drawings and the detailed description below.

2. Related Art

For several years, problems have been identified with shifting mechanisms for manual transmissions, especially in transmissions where a shifter employs an external shifter assembly that is semi-remote mounted. Typically, such designs rely on attaching the transmission to the vehicle chassis. Problems have been particularly apparent in performance automobiles where semi-remote shifters rely on an external shifter assembly that is remote-mounted.

Transmissions are often rigidly mounted to the engine, a mechanical motor which can produce a substantial amount of torque. A common design attaches the engine and transmission assembly to the chassis by a pair of isolating engine mounts and a single transmission isolator mount. Under this design, engine torque is transmitted through the driveline to the tires, where it propels the car. As the engine transmits that torque, the engine rolls to a point where the isolation mounts can hold the torque being outputted. When the transmission rolls, it tends to roll the shifter assembly with it, since half of it is attached to the transmission. It is limited in how much it can roll because the other half of the shifter is attached to the chassis, which is not rolling with the engine and transmission.

The shifter may become twisted, resulting in misalignment. The gates are controlled inside the transmission, so where the driver would anticipate the gate to be—based upon the majority of shifting being at much less roll angle during mild acceleration—will not be the same due to the excess roll under full torque. Thus far, attempts to reduce the twist have had limited positive impact on shifting accuracy. The most successful solutions offer a limited ability to withstand a certain percentage of the engine's full torque, but once that threshold is reached, it will misalign.

Examples of problems with shifters include problems with shifter movement, shifting accuracy and precision, shifting speed, and gear lock-out in vehicles such as the Ford Mustang, and in particular those car models after 2004. Drivers have experienced a range of symptoms associated with shifting issues. Shifting can be vague and have a disconnected feeling. Grinding or slow speed notchiness can occur. During high-RPM shifting, drivers often experience gear lockout when trying to shift. Speed shifting may not be possible, as the success rate in engaging the next gear is very low and missing or locking out is detrimental to the transmission and driveline. The MT-82 transmission, used in 2011+V6, GT and BOSS 302 Mustangs, has a naturally narrow gate spacing, which makes finding gates even more difficult. Modifications improving motor power can also result in factory transmission shifters having excess misalignment leading to inaccuracy and problems in speed shifting.

Difficulties associated with semi-remote shifters have been known in the automobile industry long enough for the emergence of a secondary industry aimed at rectifying these problems. In 2011, auto safety regulators investigated complaints of defective 6-speed shifters in over 30,000 Ford Mustangs. While Ford denied a defect, it did identify a problem and proposed at least one solution for its shifter. The manufacturer of the Mustang attempted to address the issue at least in part by fixing a bolt prone to slipping and recommending a different transmission fluid. However, many consumers found that these solutions did not resolve the problems with shifting.

Several companies developed and sold aftermarket solutions to improve shifting speed and accuracy. SR Performance, Hurst Shifters and Steeda are manufacturers who have offered aftermarket solutions that rely a shifter top half and a stiffer rear shifter mount. The top half is intended to offer more precise shifting feel along with shorter throws with a raised trunnion and better machined components. The rear mount is intended to allow less deflection of the shifter body in relation to the chassis, which marginally increases shift accuracy. While offering some improvement, all of these designs have the problem that the single pivot trunnion used to shorten throws also narrows the gates, which makes finding the correct gear more difficult. The additional stiffness provided by the rear mounts transmits more driveline vibration and noise into the cockpit.

Barton Shifters, also sold as Ford Racing Performance Parts, offers a somewhat similar approach except that it utilizes a dual pivot trunnion which places the fore and aft pivot higher than stock for shorter throws. However, it keeps the left to right pivot at the same elevation as stock, in order to avoid negative impact on the gate spacing.

MGW Shifters has taken a more comprehensive approach and offers a higher degree of shifting improvement. Their shifter integrates the dual pivot trunnion for shorter throws without condensing the gate pitch. They also either modify or replace the factory investment cast shifter box with a machined unit with stiffer plastic bushings for added precision, but still utilize the factory multi-jointed shift linkage to translate the shifter motion to the transmission's internal shift rod. It also uses a rear mount similar to Barton's, which does a reasonable job of controlling the shifter box roll. To aid in finding the correct gear, it uses a pair of counteracting springs in the left-to-right pivot to aid in centering the shifter. This design goes a long way towards alleviating the symptoms of the shifting issues, but still does not correct all the problems. Under full load accelerating, the MGW shifter can still lock out gears.

Whiteline uses a slightly different approach. They have a hard urethane rubber insert that fills the voids in the factory transmission mount isolator. The insert does a reasonable job of limiting the transmission roll along the axis of the driveline. It reduces the frequency of shifting inaccuracy, but does not eliminate it. The biggest issue with this aftermarket solution is a substantial increase in vibration and noise inside the cockpit.

Tremec has taken an entirely different “replace everything” approach. They utilize one of their existing transmissions, the Magnum, and stretch the tail shaft housing to accommodate the farther rearward shifter position needed for use in the 2005+ Mustang platform. They refer to this extended housing version as the Magnum XL. This is, in fact, a real solution to the issue, as it integrates the shifter to the transmission. The problem is it replaces most of the factory driveline to accommodate it. The clutch, transmission mount, cross member and driveshaft must be exchanged in addition to having to exchange the very expensive transmission. The way the speedometer sensor works is also different than the factory transmission, so an electronic adapter box must be employed to transmit the sensor signal properly for the computer to properly adjust a multitude of parameters. Consequently, there remains a need to provide a more reliable shifter for manual transmissions that would provide greater reliability and speed, but also prevent unwanted vibration from interfering with the driver.

### BRIEF SUMMARY OF THE INVENTION

The present invention is intended to resolve the problems associated with shifting, such as inaccuracy, poor precision, poor speed, and gear lock-out, without transmitting undesirable vibration to the driver. The invention offers unexpected results in smoothness, reliability, and speed. Moreover, the present invention resolves the shifting issues where both the manufacturer and other aftermarket solutions have not been able to do so without replacing substantial portions of the driveline. Still further, the design of the present invention enables a very practical modification for several types of manual transmission shifters.

One aspect of the present invention is multiple connection points between the shifter and transmission. A rigid frame is provided between the transmission mount isolator and shifter box. A first connection is accomplished from the transmission mount isolator to a lower portion of the frame, for example, a lower shifter support bracket. The lower shifter support bracket is attached to an upper shifter support bracket connected to the shifter. A second connection is accomplished by an attachment to the shifter box, which can be attached to a bracket connected to the transmission, especially where this bracket is the upper shifter support bracket.

The invention is described in further detail in the drawings and the detailed description below.

### BRIEF SUMMARY OF THE DRAWINGS

FIG. 1 is a perspective view of a transmission and shifter having multiple transmission-shifter connections of the present invention.

FIG. 2 is a perspective view of a lower shifter support bracket and mount of a transmission-shifter connection of the present invention.

FIG. 3 is a perspective view of an upper and a lower shifter support bracket of a transmission-shifter connection of the present invention.

FIG. 4 is a perspective view of an upper shifter mount.

FIG. 5 is an exploded view of a transmission and shifter having multiple transmission-shifter connections of the present invention.

FIG. 6 is a perspective view of a prior art transmission, without the multiple transmission-shifter connections of the present invention.

FIG. 7 is a perspective view of a shifter box mount of a transmission-shifter connection of the present invention.

FIG. 8 is an exploded view of a transmission and shifter having multiple transmission-shifter connections of a preferred embodiment of the present invention.

### DETAILED DESCRIPTION OF THE INVENTION

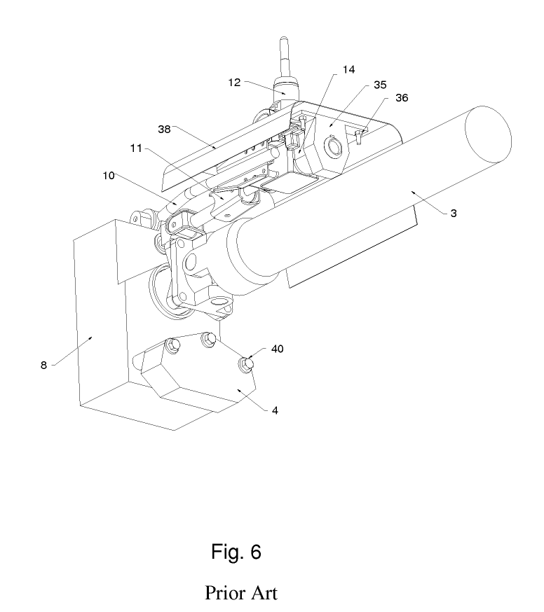

A representative transmission that may be improved by the modifications of the present invention is depicted in FIG. 6. This depiction of a portion of a transmission and shifter assembly shows key components of a semi-remote shifter assembly for an automobile such as a Ford Mustang. FIG. 6 depicts a transmission typically found in Ford Mustangs 2005 and later, and V6 and GT models in particular. However, the present invention may be applied to other transmissions. For example, the invention is intended to be used in other automobiles, such as the Dodge Challenger and Chevrolet Camaro. The invention is particularly useful for transmissions that may have been modified to enhance performance. The concept of the present invention is not limited to automobile transmissions, but may be applied generally to other transmissions to improve shifting performance.

The driveshaft 3 is shown extending beneath the vehicle body transmission tunnel 38. A transmission mount isolator 4 is secured with three transmission mount isolator-to-transmission case attachment bolts, 40. The shifter top half assembly 12 may extend upwards to a shifter handle and is in contact with the linkage 11 located under the vehicle body transmission tunnel 38. A shifter box 14 connects the linkage and shifter top half assembly, and provides an attachment to a shifter mount arm 10. The shifter box 14 may include a cast aluminum piece with one or more projections or protrusions on the rear of the shifter box 14 that may serve as an attachment point. In general, the use of “rear,” “forward,” and other directional terms is relative to the orientation of the vehicle. “Projections” and “protrusions” in the context of the shifter box are used interchangeably, without limitation to a particular technical meaning.

The rear shifter mount 35 is attached to the upper surface of the vehicle body transmission tunnel 38 with one or more rear shifter mount-to-vehicle body transmission tunnel attaching bolts secured with nuts 36. The vehicle body transmission tunnel 38 may be part of the floorboard or a rigid portion of the vehicle unibody.

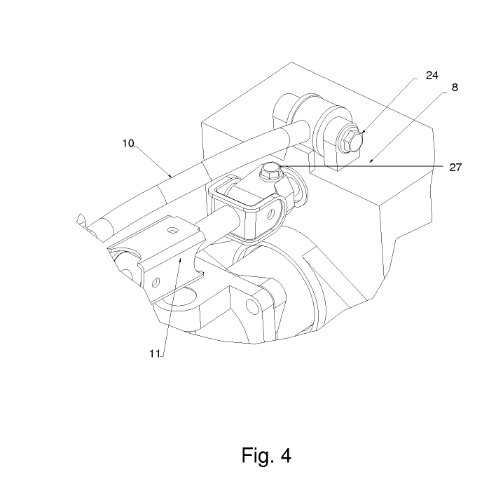

FIG. 4 shows shifter mount arm 10 attached to the transmission case 8 by a shifter mount arm-to transmission case mounting bolt 24. Beneath the shifter mount arm 10 is the shifter linkage 11 which is attached to the transmission shifter rod 28 by the shifter linkage-to-transmission shifter rod attaching bolt 27.

The transmission and shifter are connected in FIG. 6 in a typical way, resulting in excess flex under load, and ultimately poor shifting ability. Therefore, the present invention uniquely features a rigid frame located between the shifter box and a transmission mount isolator to provide greater stability and therefore enhanced shifting ability. The rigid frame of the present invention may include one or more members, and preferably includes one or more brackets. To mount a rigid frame between the transmission mount isolator and shifter box, the present invention may employ an attachment or means for securing the rigid frame to the shifter box. A means for securing the rigid frame to the shifter box may include a clamp, clamp portions, or various fittings suitable for attaching a frame to the shifter box. A shifter box may have one or more projections, and the securing means, such as one or more clamp portions, may be contoured to fit around those projections. Another aspect of the invention is the formation of an enclosure by one or more surfaces of the rigid frame. As an example, two metal brackets may be attached to each other around the driveshaft, providing a full enclosure around the driveshaft. The rigid frame may be connected to the transmission mount isolator by threading bolts through openings in the rigid frame into the transmission mount isolator.

Another aspect of the present invention is a kit that may be used to modify an existing transmission. Such a shifter improvement kit has a frame, which may include one or more brackets, and means for securing the frame to the shifter box. A shifter improvement kit of the present invention may come with fittings at the connecting ends of the brackets, with bolts and nuts provided to attach brackets to each other. Preferably, shifter improvement kit has one or more members of a rigid frame that, when mounted between the shifter box and transmission mount isolator, has surfaces that form a full enclosure.

More specifically, a shifter improvement kit of the present invention may have a frame which may include one or more brackets, preferably a first bracket and a second bracket, more preferably a lower shifter support bracket and an upper shifter support bracket. The bracket or brackets may be installed so that a rigid frame is mounted between the shifter box and transmission mount isolator. A means for securing the rigid frame to the shifter box, which may include a clamp, clamp portions, a fitting, a mount or other similar structure, connects the rigid frame to the shifter box. In many transmissions, the shifter box has a projection such as a snout extending from the rear of the shifter box, and the means for securing a frame to a shifter box may be contoured to fit around this projection. The means for securing the frame to the shifter box may include a shifter mount clamp upper portion and a shifter mount clamp lower portion, the shifter mount clamp lower portion having pins extending forward into corresponding openings isolators located on an attachment surface of an upper shifter support bracket.

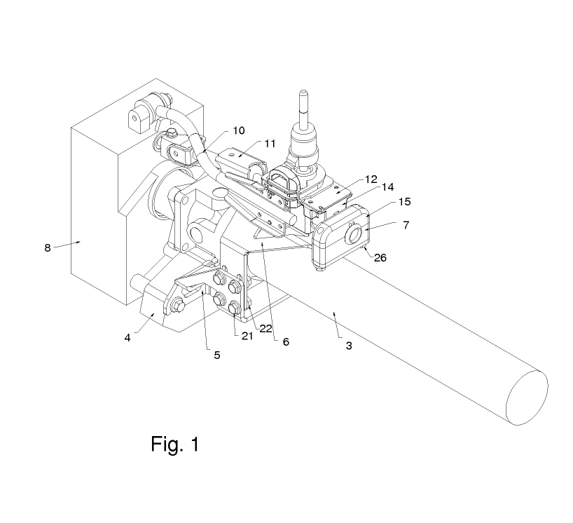

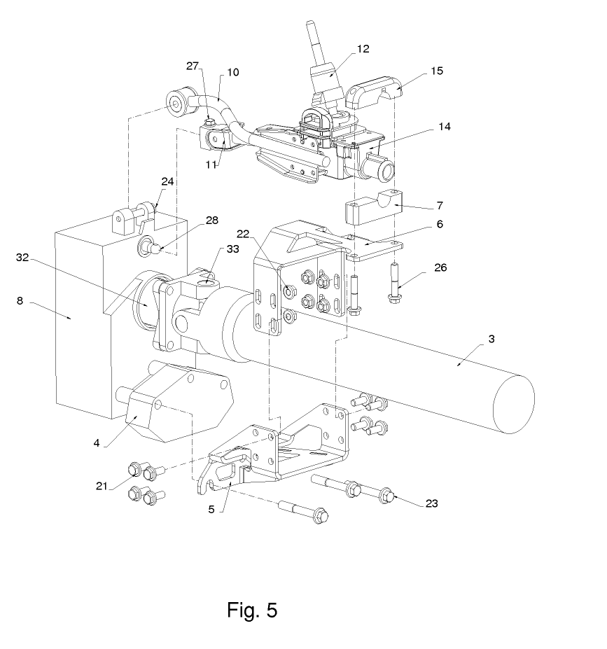

In FIG. 1, the system of the present invention is shown as applied to the transmission and shifter of FIG. 6. The system comprises a rigid frame made from one or more brackets, located between the shifter box and transmission mount isolator. An attachment such as a clamp secures the rear of the shifter box to the rigid frame. The lower shifter support bracket 5 of the rigid frame may be bolted to the transmission mount isolator 4. The lower shifter support bracket 5 may be seen more clearly in FIG. 5.

The lower shifter support bracket 5 comprises a metal bracket with four primary surfaces. A first surface is parallel to the rear surface of the transmission mount isolator 4 and may have openings allowing this first surface to be bolted to the transmission mount isolator 4 with one or more lower shifter support bracket-to-transmission mount isolator bolts 23. The first surface may have one or more cut-outs to minimize weight. In general, the brackets of the present invention may have various fittings for the various attachment points in the present invention.

A second surface of the lower shifter support bracket 5 is connected to and extends perpendicular from the top of first surface. The second surface connects the first surface to the third and fourth surfaces of the lower shifter support bracket 5. The second surface may be positioned below the driveshaft 3 and should be wide enough so that the third and fourth surfaces may extend upward from the outer edges of the second surface to clear the driveshaft 3.

The third and fourth surfaces of the lower shifter support bracket 5 are parallel to each other, and extend upwards from the second surface such that they are situated on either side of the driveshaft 3. The third and fourth surfaces each have connection points to be attached to the upper support bracket 6. As shown in FIGS. 1 and 5, a group of four lower-to-upper shifter support attaching bolts 21 and nuts 22 attach the third and fourth surfaces of the lower shifter support bracket 5 to the upper support bracket 6. The third and fourth surfaces may be triangular or trapezoidal or other suitable shape with cut-outs to optimize strength while minimizing weight.

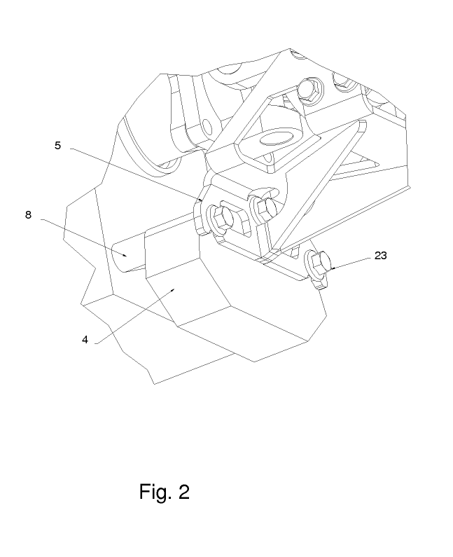

In addition to the four primary surfaces of the lower shifter support bracket 5, one or more reinforcing members may be used to provide additional strength or bracing. As shown in FIG. 2, adjacent cantilevered supports extend from the middle of the first surface of the lower shifter support bracket 5 towards the rear corners of the second surface of the lower shifter support bracket 5. These cantilevered supports may have cut-outs to minimize weight and leave space to accommodate one or more lower shifter support bracket-to-transmission mount isolator bolts 23.

The upper shifter support bracket 6 is attached to the lower shifter support bracket 5 and the shifter mount clamp 7. The upper shifter support bracket 6 may have two attachment surfaces adjacent to the third and fourth surfaces of the lower shifter support bracket 5. Each of these attachment surfaces may have openings for four lower-to-upper shifter support attaching bolts 21.

A support structure may connect the attachment surfaces of the upper shifter support bracket 6 to top surface of the upper shifter support bracket 6 which is attached to the shifter mount clamp 7. This support structure may have one or more members and bracing, resulting in a rectangular, triangular or trapezoidal shape. A bottom member of the support structure may span the two attachment surfaces. Side members of the support structure may extend upwards, optionally at an angle, to reach the top surface of the upper shifter support bracket 6.

The top surface of the upper shifter support bracket 6 may extend from the support structure rearwards above the top of the driveshaft 3 to a position where the top surface may be attached to the lower portion of shifter mount clamp 7 with upper support bracket-to-shifter mount clamp bolts 26.

The lower portion of shifter mount clamp 7 is secured to the upper shifter support bracket 6, and the upper portion of the shifter mount clamp fits around the snout extending rearwards from the shifter box 14 cast aluminum piece that connects the linkage and shifter top half assembly. Shifter mount clamp portions 7 and 15 fit around the shifter snout and may be secured with upper support bracket-to-shifter mount clamp bolts 26. These bolts 26 secure not only the lower shifter mount clamp 7 to the upper shifter support bracket 6, but also may extend through and secure the upper shifter mount clamp portion 15.

Upper and lower shifter mount clamps 7 and 15 may be solid blocks each having a semi-circular indentation to fit around and secure the shifter snout extending from the shifter box 14 that connects the linkage and shifter top half assembly.

The present invention is intended to be used with various vehicle transmissions and shifters, as one skilled in the art will understand from the drawings and detailed description of this invention. One shifter configuration that may be improved according to this invention is a single shifter mount arm connecting the shifter box to the transmission body with a single, non-rotating protrusion (snout), at the rear of the shifter box, with an axial sliding joint mounted to the chassis or body. This includes the Ford Mustang, models 2005 and later, especially the V6 and GT. However, the invention is also intended for other vehicle transmission configurations, including those with transmission shifter structures different from that depicted in FIG. 6.

Aftermarket shifters (e.g. by MGW, Ltd.) for performance automobiles may have a single shifter mount arm connecting the shifter box to the transmission body with dual non-rotating protrusions at the rear of the shifter box, with an axial sliding joint mounted to the chassis or body. The present invention may be applied by employing an attaching structure to accommodate the dual protrusions at the rear of the shifter box.

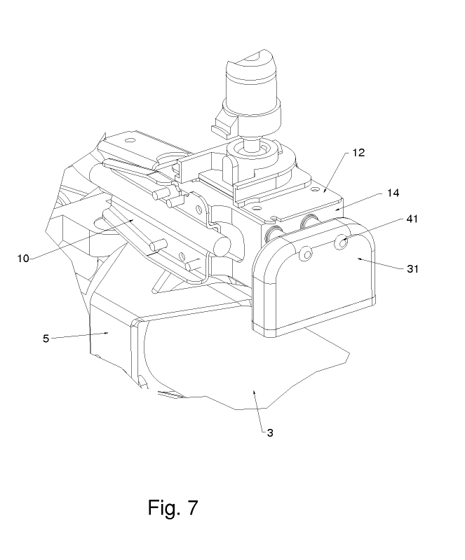

FIG. 7 shows one embodiment of the present invention that accommodates the dual protrusions on the rear of the shifter box 14. In this example, the dual protrusions are shifter box attaching pins 41. The upper shifter support bracket is attached to shifter mount block 31 which may be formed by any suitable arrangement that secures the shifter box attaching pins 41. While a clamp may be used, it is also feasible to use a single rigid block of material such as metal to provide an acceptable shifter mount block 31. Such a rigid block may have holes pre-drilled to accommodate the shifter box attaching pins 41. Alternatively, the shifter mount block may be secured around the shifter box attaching pins by adjoining two or more rigid pieces that together form a shifter mount block that can then be attached to the upper shifter support bracket 6. Examples of other variations that may be modified to offer the improved shifter of the present invention are set forth below.

Dodge Challengers from 2009 and later, as well as the 2007 Mustang GT500, may have a dual shifter mount arm connecting the shifter box to the transmission body with a single, non-rotating protrusion (snout), at the rear of the shifter box, with an axial sliding joint mounted to the chassis or body.

Camaro models 2010 and later may have a dual shifter mount arm connecting the shifter box to the transmission body with dual, non-rotating protrusions, at the rear of the shifter box, with an axial sliding joint mounted to the chassis or body.

Some vehicles may employ a single shifter mount arm with an integral shifter trunnion or pivot that attaches to the transmission case, and chassis or body. Similarly, another configuration may be a dual shifter mount arm with an integral shifter trunnion or pivot that attaches to the transmission case, and chassis or body.

The above transmission-shifter configurations are provided for purposes of example only, as the invention may be applied to a wide variety of transmission-shifter designs by replacing the connection from the protrusion of the shifter box to the chassis or body with the connection described herein from the shifter box 14 to the transmission mount isolator 4.

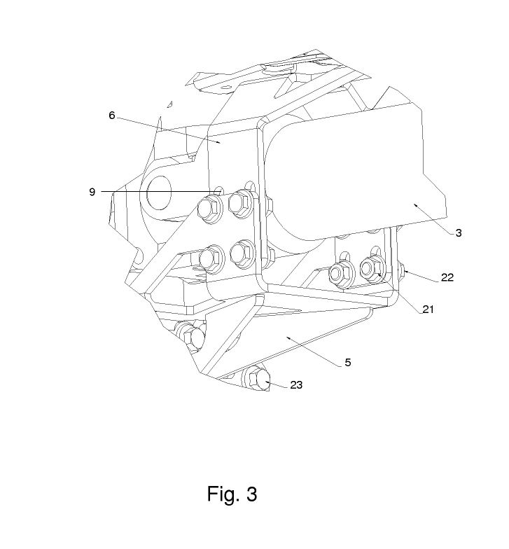

One aspect of the frame located between the shifter box and the transmission mount isolator of the present invention is that it may enclose the driveshaft 3 as shown in FIG. 3. Lower shifter support bracket 5 may join the upper shifter support bracket 6 around the driveshaft 3. As one skilled in the art will appreciate, this embodiment of the present invention allows for retrofitting an existing transmission-shifter configuration with the transmission-shifter connection of the present invention. This accomplished my mounting one or more brackets around the driveshaft without interfering with the drivetrain of the vehicle. As exemplified in FIG. 3, the lower shifter support bracket 5 may be attached to the transmission mount isolator 4 with one or more lower shifter support bracket-to-transmission mount isolator bolts 23. The lower shifter support bracket 5 may have holes attachment points corresponding to attachment points on the upper shifter support bracket 6. Although a group of four lower-to-upper shifter support attaching bolts 21 and nuts 22 attach the lower shifter support bracket 5 to the upper support bracket 6 in FIG. 3, other attachment means may be used according to the present invention. Means for attaching includes but is not limited to rivets, welds, bolts, screws and other attachment means that will be apparent to one skilled in the art. It is also within the invention to use cast metal where the different portions of one or more brackets are joined together when a single piece of metal is cast. Nor is the bracket limited by material. While metal is described above, it is also possible to use a composite such as carbon fiber to provide the connection of the present invention.

As shown in FIG. 3, the brackets 5 and 6 fully enclose the driveshaft 3. When the brackets are made from steel with a thickness of ¼ inch or more, and a width around the driveshaft 3 of at least two inches, located within six inches of the universal joint 33, then the present invention additionally serves to satisfy NHRA Safety Requirement 2:4 by providing a full enclosure around the driveshaft 3. While not required according to the present invention, this configuration serves to isolate the driveshaft 3 in the event of a failure at the universal joint 33. Thus, the present invention may address open driveshaft 3 safety while simultaneously providing improved shifting capabilities.

Thus, a preferred design configuration of the present invention may employ a two-piece bracket that wraps around the driveshaft 360 degrees to provide a connection between the transmission mount isolator 4 and the rear of the shifter box 14. Alternate configurations of the present invention may include a C-shaped bracket that wraps 180 degrees around the left or right side of the driveshaft 3. This configuration may be useful when space constraints do not allow for 360 degrees wrap-around the driveshaft and where an integral driveshaft safety loop is not necessary or desirable.

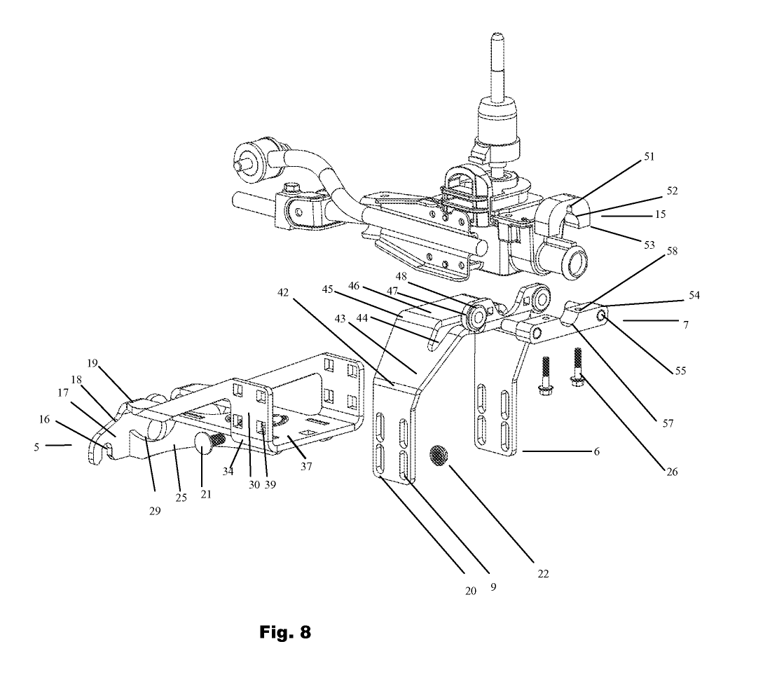

A preferred embodiment of the present invention is illustrated in FIG. 8. This embodiment of the invention has a lower shifter support bracket 5, an upper shifter support bracket 6, a shifter mount clamp lower portion 7, and a shifter mount clamp upper portion 15.

The lower shifter support bracket 5 has a first surface 18 facing the transmission mount isolator. The surface 18 of the lower shifter support bracket facing the transmission mount isolator has one or more openings 16 for a lower shifter support bracket-to-transmission mount isolator bolt, by which the lower shifter support bracket 5 may be attached to the transmission mount isolator. An angled portion 19 of the lower shifter support bracket is located between the first surface 18 of the lower shifter support bracket facing the transmission case and the main body 37, in this embodiment a second surface, of the lower shifter support bracket that supports a third surface 30 of the lower shifter support bracket that adjoins the upper shifter support bracket. The lower shifter support bracket 5 may also have a cantilever support 25 that extends rearwards from a cantilever support surface 17 of the lower shifter support bracket connected to the cantilever support 25. Two cantilever supports may extend from the cantilever support surface 17 to the main body of the lower shifter support bracket such that the cantilever supports are parallel to each other, or such that they form a “V” (as in FIG. 2) with the apex located at the cantilever support surface 17, maximizing access to the bolt openings 16. An angled portion 34 connects the main body 37 of the lower shifter support bracket to the surface 30 of lower shifter support bracket adjoining the upper shifter support bracket. The surface 30 of the lower shifter support bracket may also be connected to the main body 37 of the lower shifter support bracket by bracing that extends from the top of the surface 30 to a portion of the main body of the lower shifter support bracket near the surface 18 facing the transmission case. The surface 30 of the lower shifter support bracket adjoining the upper shifter support bracket may contain an opening 39 for a lower-to-upper shifter support attaching bolt 21. Preferably, there are four such openings located near the perimeter of the surface 30 of the lower shifter support bracket adjoining the upper shifter support bracket. In a preferred embodiment, rather than a single surface 30, there may also be a parallel surface on the opposite side of the main body 37. These parallel third and fourth surfaces of the lower shifter support bracket adjoin the upper shifter support bracket, each extending from an angled portion located on opposite sides of the main body 37 of the lower shifter support bracket, so that the two surfaces form a partial enclosure on either side of the driveshaft. In a preferred embodiment, the two surfaces of the lower shifter support bracket adjoining the upper shifter support bracket rise from the main body of the lower shifter support bracket to form a “U” shape, providing the bottom half of an enclosure around the driveshaft.

The upper shifter support bracket 6 has a surface 20 adjoining the lower shifter support bracket, and preferably two such surfaces corresponding and attaching to the third and fourth surfaces of the lower shifter support bracket. Each such surface 20 has at least one opening 9 for a lower-to-upper shifter support attaching bolt 21. Preferably, there are four such openings, each corresponding to an opening 39 in the lower shifter support bracket surface 30. In a preferred embodiment, the opening 39 is an elongated slot, with the elongated portion extending along the vertical axis allowing for vertical adjustment of the shifter assembly. A lower-to-upper shifter attaching nut 22 fits around the corresponding bolt 39 to secure the surface 30 of the lower shifter support bracket to the surface 20 of the upper shifter support bracket.

An angled portion 42 connects the surface 20 of the upper shifter support bracket adjoining the lower shifter support bracket to an intermediate surface 43 of the upper shifter support bracket. Intermediate surface 43 is situated between the surface 20 and the top 46 of the upper shifter support bracket. An angled portion 45 connects the intermediate surface 43 to the top 46 of the upper shifter support bracket. Optionally, there may be an opening 44 in the top of the upper shifter support bracket. In the preferred embodiment illustrated, two surfaces 20 are situated on either side of the driveshaft and connected to the corresponding surfaces 30 of the lower shifter support bracket. Each surface 20 extends upward to an angled portion 45 and then an intermediate surface 43 around either side of the driveshaft such that when attached to opposite sides of the top 46 of the upper shifter support bracket, a full enclosure is provided around the driveshaft.

The top surface 46 of the upper shifter support bracket may be situated beneath the shifter box, and more particularly beneath the shifter box cast aluminum piece that holds the linkage and shifter assembly. Positioned towards the rear of the top surface 46, an attachment surface 47 of the upper shifter support bracket may be positioned to adjoin the shifter mount clamp, lower portion 7. This attachment surface 47 of the upper shifter support bracket adjoining the lower portion of the shifter mount clamp may extend upwards at a right angle from the top surface 46 of the shifter support bracket. The attachment surface 47 may have openings or other attachment points to enable attachment to the lower portion of the shifter mount clamp 7. Preferably, the attachment surface 47 has one or more openings to allow it to be bolted or pinned to the lower portion of the shifter mount clamp. More preferably, attachment surface 47 has an isolator 48 of rubber, polymer, or any other suitable material that allows for the required attachment between the upper shifter support bracket 6 and shifter mount clamp 7, 14. Preferably, there is at least one isolator 48 mounted on each opposing side along the width of the attachment surface 47. At least one pin 55 may connect the lower portion of the shifter mount clamp 7 to the isolator 48. Although the exact type of isolator is not critical to the invention, it will be appreciated by one of skill in the art that an isolator may allow a sufficiently rigid attachment while limiting shock or vibration.

In a preferred embodiment of the present invention, the upper shifter support bracket is attached to a shifter mount clamp secured around a projection from the shifter, such as a shifter snout. The invention is not limited to any particular shifter snout or projection. However, a preferred embodiment employs a shifter mount clamp having an upper portion 15 and a lower portion 7. The two clamp portions 15 and 7 may be secured around a shifter snout by any suitable method, for example, at least one bolt 26 that passes upward through an opening 58 in the lower shifter mount clamp portion 7, allowing the clamp to be tightened around the shifter snout by screwing the bolt 26 into corresponding threads in the upper portion of the shifter mount clamp 15.

In the preferred embodiment, the upper and lower portions of the shifter mount clamp 15 and 7 may be contoured to assist in securing the shifter snout. For example, the upper portion of the shifter mount clamp 15 may have a groove 51 designed to accommodate a linear ridge on the shifter snout. There may also be a surface 52 of the upper portion of the shifter mount clamp fitting around and in contact with the upper circumference of the shifter snout. Similarly, a surface 57 of the lower portion of the shifter mount clamp 7 may be designed to fit around the lower circumference of the shifter snout. As one of ordinary skill will appreciate, there are many variations of surface geometries available to accommodate the various surfaces of shifter projections, and the present invention is not limited to a particular shifter mount clamp. Moreover, a preferred embodiment may have a lower portion of the shifter mount clamp 7 with a surface 54 that is in contact with a corresponding surface 53 of the upper portion of the shifter mount clamp 15.

The result of this preferred embodiment is: (1) a clamp secured around a projection of the shifter, connected by two isolator mounts to (2) an upper shifter support bracket having the shape of an upside down “U,” which in turn is connected to (3) a U-shaped portion of a lower shifter support bracket which is connected to the transmission mount isolator.

In this way, the U-shaped portion of the lower shifter support bracket when attached to the upside down U-shaped portion of the upper shifter support bracket fully encloses the driveshaft fulfilling the requirement of a safety loop surrounding the drive shaft.

The invention is not intended to be limited to a specific “U” shape. For example, the lower support bracket 5 may have two parallel surfaces connected by a surface orthogonal to the parallel surfaces. However, the lower support bracket may also have a single curvilinear surface that wraps around a portion of the driveshaft. Similarly, the upper support bracket 6 may have the geometry as shown in FIG. 8, but it also may resemble an inverted lower support bracket with two parallel surfaces connected by an orthogonal surface, or alternatively a single curvilinear surface.

The present invention may also employ a single-sided bracket that flanks the driveshaft 3 to attach to the shifter body at the shifter mount arm, instead of the protrusions located on the back of the shifter box. This may be combined with a non-flexing bushing in the shifter mount arm-to-transmission case connection to prevent deflection. This configuration is useful for light-weight and may be used with a twin parallel shifter mounting arm arrangement.

The present invention may have a single-sided bracket that flanks the driveshaft and replaces the factory shifter mount arm to provide a rigid, solid side-mount surface for attachment to the shifter box.

A single or dual support rod may connect the rear of the shifter box to the transmission in a triangular or trapezoidal fashion.

It is considered within the present invention to replace a standard transmission mount isolator.

It is also considered within the present invention to replace a standard shifter box.

Generally, the present invention places the additional transmission mounting point at some other mount location on the transmission case, either utilizing existing mounting points or modifications to provide mounting points.

The invention may be incorporated as an original manufacturing design, or it may be applied as a retrofit kit enabling a mechanic to attach brackets of the present invention and shifter box connection so that the shifter box is connected to the transmission mount isolator rather than the chassis or part of the unibody.

A kit according to the present invention may have brackets as set forth FIG. 5 or FIG. 8. A kit according to the present invention may have alternative bracket designs. For example, although a preferred embodiment describes upper and lower shifter support brackets, the invention may be accomplished with left and right support brackets. Such a variant may partially or fully enclose the driveshaft.

The invention may also incorporate a method of providing improved shifting performance by accomplishing the shifter-transmission mount isolator connection described above.

The many features and advantages of the present invention are apparent from the written description and, thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be included as falling within the scope of the invention.

I claim:

1. An improved shifter comprising:
a shifter box connected to a shifter linkage, the shifter box having a front and a rear;
a rigid frame located between the shifter box and a transmission mount isolator; and
an attachment securing the rear of the shifter box to the rigid frame.

2. The improved shifter of claim 1 wherein the attachment securing the rear of the shifter box comprises two portions of a clamp secured around a projection on the rear of the shifter box.

3. The improved shifter of claim 1 wherein the rigid frame comprises two brackets attached to each other.

4. The improved shifter of claim 1 wherein the rigid frame comprises an upper shifter support bracket attached to a lower shifter support bracket attached to the transmission mount isolator.

5. The improved shifter of claim 1 further comprising a projection located on the rear of the shifter box; a shifter mount clamp upper portion and a shifter mount clamp lower portion, secured around the projection on the rear of the shifter box; the shifter mount clamp lower portion attached to an upper shifter support bracket; a lower shifter support bracket attached to the upper shifter support bracket; and the lower shifter support bracket attached to the transmission mount isolator.

6. The improved shifter of claim 1 wherein the rigid frame provides an enclosure around a driveshaft.

7. The improved shifter of claim 5 wherein the rigid frame provides an enclosure around a driveshaft.

8. The improved shifter of claim 5 further comprising a full enclosure around a driveshaft, the full enclosure provided by the upper shifter support bracket and the lower shifter support bracket.

9. A shifter improvement kit comprising:
a rigid frame that may be mounted between a shifter box and a transmission mount isolator; and
a clamp contoured to fit around a projection on the rear of a shifter box.

10. The shifter improvement kit of claim 9 wherein the clamp comprises: a shifter mount clamp upper portion and a shifter mount clamp lower portion.

11. The shifter improvement kit of claim 9 wherein the rigid frame comprises a first bracket and a second bracket, the first bracket having fittings to connect to the second bracket.

12. The shifter improvement kit of claim 9 wherein the rigid frame comprises an upper shifter support bracket and a lower shifter support bracket.

13. The shifter improvement kit of claim 9 wherein the rigid frame comprises an upper shifter support bracket and a lower shifter support bracket, and wherein the rigid frame, when mounted between the shifter box and transmission mount isolator, has surfaces that form a full enclosure.

14. A shifter improvement kit comprising:
a rigid frame that may be mounted between a shifter box and a transmission mount isolator; and
a means for securing the rigid frame to the shifter box.

15. The shifter improvement kit of claim 14 wherein the rigid frame comprises a first bracket and a second bracket, the first bracket having fittings to connect to the second bracket.

16. The shifter improvement kit of claim 14 wherein the rigid frame comprises an upper shifter support bracket and a lower shifter support bracket.

17. The shifter improvement kit of claim 14 wherein the rigid frame comprises an upper shifter support bracket and a lower shifter support bracket; and wherein the rigid frame, when mounted between the shifter box and transmission mount isolator, has surfaces that form a full enclosure.

18. The shifter improvement kit of claim 14 further comprising an upper shifter support bracket and a lower shifter support bracket; and wherein the rigid frame, when mounted between the shifter box and transmission mount isolator, has surfaces that form a full enclosure.

19. The shifter improvement kit of claim 14 wherein the rigid frame comprises an upper shifter support bracket, the upper shifter support bracket having an attachment surface with openings for connecting the upper shifter support bracket to the means for securing the rigid frame to the shifter box.

20. The shifter improvement kit of claim 14 wherein the means for securing the rigid frame to the shifter box comprises a shifter mount clamp upper portion and a shifter mount clamp lower portion, the shifter mount clamp lower portion having pins extending forward into corresponding openings located on an attachment surface of an upper shifter support bracket.
